(19) United States
(12) Patent Application Publication
(10) Pub. No.: US 2024/0429503 A1
(43) Pub. Date: Dec. 26, 2024

(54) ENERGY STORAGE DEVICE

(71) Applicant: GS Yuasa International Ltd., Kyoto (JP)

(72) Inventors: Ryoichi OKUYAMA, Kyoto (JP); Kazuya OKABE, Kyoto (JP)

(73) Assignee: GS Yuasa International Ltd., Kyoto (JP)

(21) Appl. No.: 18/273,984

(22) PCT Filed: Jan. 21, 2022
(86) PCT No.: PCT/JP2022/002157

§ 371 Date: Jul. 25, 2023

(30) Foreign Application Priority Data
Jan. 29, 2021 (JP) 2021-012862

(51) Int. Cl. H01M 50/15; H01M 10/04; H01M 50/103; H01M 50/169; H01M 50/547

(52) U.S. Cl. CPC H01M 50/15; H01M 10/0431; H01M 50/103; H01M 50/169; H01M 50/547

(57) ABSTRACT

An energy storage device includes: an electrode assembly formed by winding a plurality of plates; and a rectangular parallelepiped case housing the electrode assembly. The case is constructed by welding: a lid formed of a pair of short side surfaces of the case, which face each other in a winding-axis direction, and an other one surface of the case; and a case body formed of three surfaces, except for the pair of short side surfaces and the other one surface, of the case.

### TECHNICAL FIELD

The present invention relates to an energy storage device including an electrode assembly.

### BACKGROUND ART

Conventionally, there has been known an energy storage device with a rectangular case housing an electrode assembly formed by winding plates (e.g., see Patent Document 1).

### PRIOR ART DOCUMENT

### Patent Document

Patent Document 1: JP-A-2010-73580

### SUMMARY OF THE INVENTION

### Problems to be Solved by the Invention

In recent years, it has been studied to adopt an electrode assembly that is made longer in the winding-axis direction, but when such an electrode assembly is used, it is difficult to accommodate the electrode assembly in a case during assembly, and the load on the electrode assembly may increase.

An object of the present invention is to provide an energy storage device capable of reducing a load on an electrode assembly during assembly.

### Means for Solving the Problems

In order to achieve the above object, an energy storage device according to one aspect of the present invention includes: an electrode assembly formed by winding a plurality of plates; and a case of a rectangular parallelepiped shape that housing the electrode assembly. The case is constructed by welding a lid and a case body, the lid is formed of a pair of short side surfaces of the case, the pair of short side surfaces facing each other in a winding-axis direction of the electrode assembly, and formed of an other one surface of the case, and the case body is formed of three surfaces, except for the pair of short side surfaces and other one surface, of the case.

### ADVANTAGES OF THE INVENTION

According to the present invention, it is possible to provide an energy storage device capable of reducing a load on an electrode assembly during assembly.

### BRIEF DESCRIPTION OF THE DRAWINGS

FIG. 1 is a perspective view illustrating an appearance of an energy storage device according to an embodiment.

FIG. 2 is an exploded perspective view illustrating each component of the energy storage device according to the embodiment in an exploded state.

FIG. 3 is a perspective view illustrating a configuration of an electrode assembly according to the embodiment.

FIG. 4 is an enlarged cross-sectional view illustrating a joining structure of a case body and a lid according to the embodiment.

FIG. 5 is an exploded perspective view illustrating a case according to Modification Example 1 of the embodiment.

FIG. 6 is an exploded perspective view illustrating a case according to Modification Example 2 of the embodiment.

FIG. 7 is an exploded perspective view illustrating a case according to Modification Example 3 of the embodiment.

### MODE FOR CARRYING OUT THE INVENTION

An energy storage device according to one aspect of the present invention includes: an electrode assembly formed by winding a plurality of plates; and a case of a rectangular parallelepiped shape housing the electrode assembly. The case is constructed by welding a lid and a case body, the lid is formed of a pair of short side surfaces of the case, the pair of short side surfaces facing each other in a winding-axis direction of the electrode assembly, and formed of an other one surface of the case, and the case body is formed of three surfaces, except for the pair of short side surfaces and other one surface, of the case.

According to this, the lid is formed of the pair of short side surfaces and the other one surface of the case, so that the space between the pair of short side surfaces is open in a state before assembly. Hence the electrode assembly long in the winding-axis direction can be easily disposed between the pair of short side surfaces. Therefore, it is possible to reduce the load on the electrode assembly during assembly.

An electrode terminal may be provided on each of the pair of short side surfaces.

According to this, in the case provided with the electrode terminal on each of the pair of short side surfaces, it is also possible to reduce the load on the electrode assembly during assembly.

The lid may form the top surface of the case as the other one surface, and the case body may form a pair of long side surfaces and a bottom surface of the case as three surfaces except for the other one surface.

According to this, the lid is formed of the pair of short side surfaces and the top surface of the case, whereby each of spaces disposed in the pair of long side surfaces sides is open between the pair of short side surfaces. That is, when the electrode assembly is disposed between the pair of short side surfaces, a tab and a current collector can be joined to each other from one long side surface side or the other long side surface side. This allows for a greater degree of freedom in joining the tab and the current collector.

The electrode assembly may include a body long in the winding-axis direction; and a tab protruding from each of both end faces of the body in the winding-axis direction.

According to this, in the energy storage device that includes the electrode assembly including the tabs protruding from both end faces in the winding-axis direction respectively, it is also possible to prevent the load on the electrode assembly during assembly.

A positive electrode tab and a negative electrode tab may be provided as the tabs on each of both end faces of the body, and on each of the pair of short side surfaces of the lid, a positive electrode terminal and a positive current collector are provided corresponding to the positive electrode tab, and a negative electrode terminal and a negative current collector may be provided corresponding to the negative electrode tab.

According to this, the current collector is joined to each tab of the electrode assembly. However, as the electrode assembly becomes larger and more current-carrying, the current collector becomes thicker accordingly. The thick current collector is difficult to deform. For example, even when an attempt is made to house the electrode assembly in the case after the current collector is joined to the tab, there is a possibility that the current collector cannot be smoothly housed in the case because the current collector is difficult to deform. Here, in the present aspect, the positive electrode terminal and the positive current collector, and the negative electrode terminal and the negative current collector are provided on each of the pair of short side surfaces of the lid, so that the respective tabs can be joined to their respective current collectors after the electrode assembly is disposed between the pair of short side surfaces. Accordingly, the ease of assembly of the energy storage device can be enhanced, and furthermore, the load on the electrode assembly during assembly can also be reduced.

The positive electrode tab and the negative electrode tab provided on an one end face of both end faces of the body, and the positive electrode tab and the negative electrode tab provided on an other end face of both end faces of the body may be arranged in an inverted manner.

The inventor of the present application has found that when the arrangement of the positive electrode tab and the negative electrode tab is inverted between the one end face and the other end face of the body of the electrode assembly, the resistance of the electrode assembly during charge-discharge is reduced compared to when the arrangement of the positive electrode tab and the negative electrode tab is not inverted. That is, when the positive electrode tab and the negative electrode tab provided on the one end face and the positive electrode tab and the negative electrode tab provided on the other end face are arranged in an inverted manner in the body of the electrode assembly, it is possible to reduce the resistance of the electrode assembly during charge-discharge. This is suitable for an electrode assembly that is long in the winding- axis direction and tends to have high resistance.

The lid may include a reinforcing portion bridged between the pair of short side surfaces.

According to this, the reinforcing portion bridged between the pair of short side surfaces is provided on the lid, thereby making it possible to enhance the strength of the lid. This stabilizes the shape of the lid during assembly and can thus enhance the ease of assembly with the case body.

The reinforcing portion may be provided continuously with each of a pair of ends of a top surface of the case, the pair of ends being along the winding-axis direction.

According to this, the reinforcing portion is provided continuously with each of the pair of ends of the top surface of the lid, thereby making it possible to further stabilize the shape of the lid.

Stepped joint surfaces, superimposed to be assembled with each other, are formed on each of the case body and the lid.

When laser welding is performed, a laser beam may penetrate the case to damage the electrode assembly. In order to prevent this, the stepped joint surfaces superimposed to be assembled with each other are formed on each of the case body and the lid, respectively, and the boundary of the steps can be irradiated with a laser beam. Hence the case body is present ahead of the laser beam, so that the laser beam is less likely to penetrate the inside of the case, and damage to the electrode assembly can be prevented.

Hereinafter, an energy storage device according to an embodiment of the present invention (including its modification examples) will be described with reference to the drawings. Note that any of the embodiment and its modifications described below is a comprehensive or specific example. Numeral values, shapes, materials, components, placement positions and connection forms of the components, manufacturing steps, a sequence of the manufacturing steps, and the like shown in the following embodiment are only examples and are not intended to limit the present invention. In the drawings, dimensions and the like are not illustrated strictly. In the drawings, the same or similar components are denoted by the same reference numerals.

In the following description and drawings, a direction along the winding axis of an electrode assembly, the extending direction of the electrode assembly, or the opposing direction of the short side surfaces of a case is defined as the X-axis direction. The opposing direction of the long side surfaces of the case or the thickness direction of the case is defined as the Y-axis direction. The direction in which the bottom surface of the case body of the case and the top surface of the lid are aligned or the vertical direction is defined as the Z-axis direction. The X-axis direction, the Y-axis direction, and the Z-axis direction are direction intersecting (orthogonal in the present embodiment) each other. Although the Z-axis direction may not be the vertical direction depending on the manner of use, for the sake of convenience of description, an example will be given of an instance in which the winding axis of the electrode assembly is along the horizontal direction when the energy storage device is used, that is, an instance in which the X-axis direction and the Y-axis direction are along the horizontal direction, and the Z-axis direction is the vertical direction.

In the following description, for example, an X-axis plus direction indicates an arrow direction of the X-axis, and an X-axis negative direction indicates a direction opposite to the X-axis positive direction. The same applies to the Y-axis direction and the Z-axis direction. Further, expressions indicating relative directions or postures, such as parallel and orthogonal, strictly include instances in which the directions or postures are not the same. For example, two directions being orthogonal to each other not only means that the two directions are completely orthogonal to each other but also means that the two directions are substantially orthogonal to each other, that is, the two directions include a difference of, for example, about several percent.

### EMBODIMENT

### 1. General Description of Energy Storage device

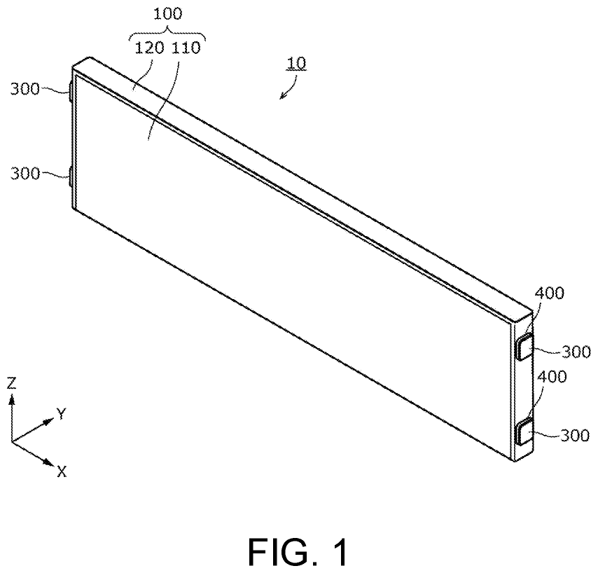

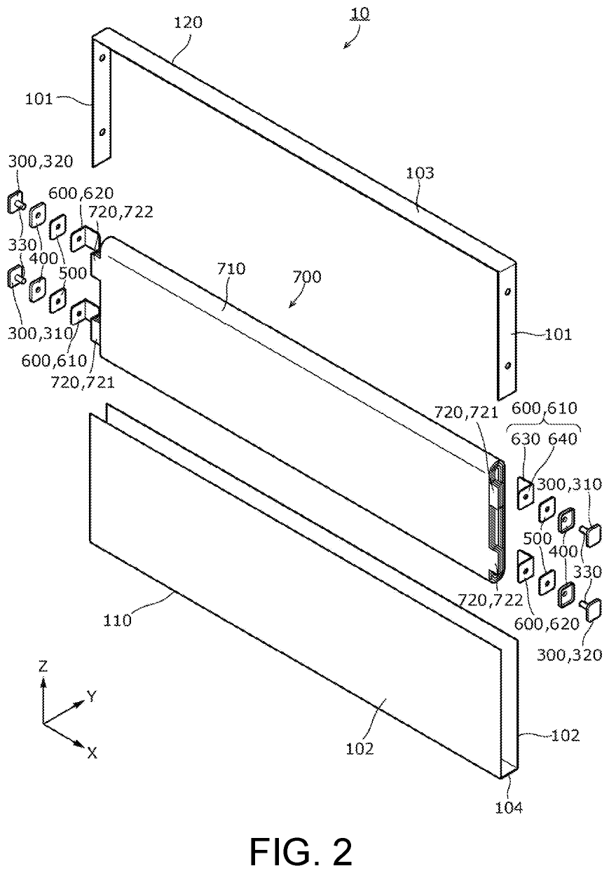

First, a general description of an energy storage device 10 in the present embodiment will be given with reference to FIG. 1 and FIG. 2. FIG. 1 is a perspective view illustrating the external appearance of the energy storage device 10 according to the present embodiment. FIG. 2 is an exploded perspective view illustrating respective components of the energy storage device 10 according to the present embodiment in an exploded state.

The energy storage device 10 is a secondary battery (battery cell) capable of storing and releasing electricity and is specifically a nonaqueous electrolyte secondary battery such as a lithium-ion secondary battery. The energy storage device 10 is used as, for example, a battery or the like for driving or starting an engine of a moving body such as an automobile, a motorcycle, a watercraft, a ship, a snowmobile, an agricultural machine, a construction machine, or a railway vehicle for electric railways. Examples of the automobile include an electric vehicle (EV), a hybrid electric vehicle (HEV), a plug-in hybrid electric vehicle (PHEV), and a gasoline vehicle. Examples of the railway vehicle for electric railways include a train, a monorail, a linear motor car, and a hybrid train provided with both a diesel engine and an electric motor. The energy storage device 10 can also be used as a stationary battery or the like used for home use, business use, or the like.

Note that the energy storage device 10 is not limited to the nonaqueous electrolyte secondary battery but may be a secondary battery except for the nonaqueous electrolyte secondary battery or may be a capacitor. The energy storage device 10 may not be a secondary battery but may be a primary battery that can use stored electricity without being charged with electricity by a user.

As illustrated in FIG. 1 and FIG. 2, the energy storage device 10 includes a case 100, two pairs of electrode terminals 300, and two pairs of outer gaskets 400. Two pairs of inner gaskets 500, two pairs of current collectors 600, and an electrode assembly 700 are housed in the case 100. Specifically, a pair of (positive electrode side and negative electrode side) members is arranged on an one end face of the case 100 in the X-axis positive direction, and the remaining pair of (positive electrode side and negative electrode side) members is arranged on the other end face of the case 100 in the X-axis negative direction. More specifically, on the one end face of the case 100 in the X-axis positive direction, each member on the positive electrode side is disposed in the Z-axis positive direction, and each member on the negative electrode side is disposed in the Z-axis negative direction. On the other end face of the case 100 in the X-axis negative direction, each member on the negative electrode side is disposed in the Z-axis positive direction, and each member on the positive electrode side is disposed in the Z-axis negative direction. That is, the members on the positive electrode side and the members on the negative electrode side are arranged in an inverted (vertically inverted) manner as viewed in the X-axis direction between the one end face and the other end face of the case 100.

The case 100 is filled with an electrolyte solution (nonaqueous electrolyte), which is not illustrated. The type of the electrolyte solution is not particularly limited as long as the electrolyte solution does not impair the performance of the energy storage device 10, and various electrolyte solutions can be selected. In addition to the above constituent elements, a spacer disposed on the side, the lower side, or the like of the electrode assembly 700, an insulating film enclosing the electrode assembly 700 and the like, or the like may be disposed.

The case 100 is a rectangular parallelepiped (prismatic or box-shaped) case long in the X-axis direction. In the case 100, both end faces facing each other in the X-axis direction are short side surfaces 101, and both end faces facing each other in the Y-axis direction are long side surfaces 102. The pair of short side surfaces 101 is the one end face and the other end face of the case in the X-axis direction where each member on the positive electrode side and each member on the negative electrode side described above are provided. Further, in case 100, of both end faces facing each other in the Z-axis direction, the end face in the Z-axis positive direction is a top surface 103, and the end face in the Z-axis negative direction is a bottom surface 104.

The case 100 includes a case body 110 and a lid 120, and the case body 110 and the lid 120 are assembled to form a rectangular parallelepiped shape. The case body 110 is formed of the pair of long side surfaces 102 and the bottom surface 104. The lid 120 is formed of the pair of short side surfaces 101 and the top surface 103.

Specifically, case body 110 is a substantially U-shaped sheet metal with its upper side open as viewed in the X-axis direction. The case body 110 includes flat and rectangular long sidewalls forming the pair of long side surfaces 102 at both ends in the Y-axis direction, and includes a flat and rectangular bottom wall forming the bottom surface 104 at the end in the Z-axis negative direction.

The lid 120 is a substantially U-shaped sheet metal with its lower side open as viewed in the Y-axis direction. The lid 120 includes flat and rectangular short sidewalls forming the pair of short side surfaces 101 at both ends in the X-axis direction, and includes a flat and rectangular top wall forming the top surface 103 at the end in the Z-axis positive direction.

With such a configuration, the case 100 has a structure in which, after the housing of the electrode assembly 700 and the like into the case body 110, the case body 110 and the lid 120 are joined by welding or the like to seal the inside. The material of the case 100 (case body 110 and lid 120) is not particularly limited but is preferably weldable metal such as stainless steel, aluminum, an aluminum alloy, iron, or a plated steel plate.

Although not illustrated, an electrolyte solution filling portion and a gas release valve are formed in the lid 120. The gas release valve is a safety valve that releases pressure inside the case 100 when the pressure increases excessively. The electrolyte solution filling portion is a part for filling the inside of the case 100 with an electrolyte solution at the time of manufacturing the energy storage device 10.

The electrode terminal 300 is a terminal member (positive electrode terminal 310 and negative electrode terminal 320) electrically connected to the electrode assembly 700 through the current collector 600. That is, the electrode terminal 300 is a metal member for introducing the electricity stored in the electrode assembly 700 to the external space of the energy storage device 10 and for introducing the electricity into the internal space of the energy storage device 10 in order to store the electricity in the electrode assembly 700. The material of the electrode terminal 300 is not particularly limited, but for example, the electrode terminal 300 (positive electrode terminal 310 and negative electrode terminal 320) is formed of a conductive member such as aluminum, an aluminum alloy, copper, or a copper alloy. The electrode terminal 300 is connected (joined) to the current collector 600 by swaging, welding, or the like and is attached to the lid 120. In the present embodiment, the electrode terminal 300 is provided with the shaft 330, and the shaft 330 is connected (joined) to the current collector 600 by being swaged while penetrating the outer gasket 400, the inner gasket 500, and the current collector 600.

The current collectors 600 are conductive current collecting members (positive current collector 610 and negative current collector 620). that are arranged as a pair on each side of the electrode assembly 700 in the X-axis direction. The current collector 600 is connected (joined) to the electrode assembly 700 and the electrode terminal 300, and electrically connects the electrode assembly 700 and the electrode terminal 300. Specifically, the current collector 600 integrally includes a first connection 630 and a second connection 640. The first connection 630 is connected (joined) to a tab 720 of the electrode assembly 700 to be described later by welding, swaging, or the like. The second connection 640 is connected (joined) to the electrode terminal 300 by welding, swaging, or the like and is fixed to the lid 120 as described above. Each of the first connection 630 and the second connection 640 is a flat part and is formed by bending one sheet metal. The material of the current collector 600 is not particularly limited, but for example, the positive current collector 610 is formed of a conductive member such as aluminum or an aluminum alloy similarly to a positive electrode substrate 741 of the electrode assembly 700 to be described later, and the negative current collector 620 is formed of a conductive member such as copper or a copper alloy similarly to a negative electrode substrate 751 of the electrode assembly 700 to be described later.

The outer gasket 400 is a plate-shaped rectangular insulating sealing member that is disposed between the lid 120 of the case 100 and the electrode terminal 300 and insulates and seals between the lid 120 and the electrode terminal 300. The inner gasket 500 is a plate-shaped rectangular insulating sealing member that is disposed between the lid 120 and the current collector 600 and insulates and seals between the lid 120 and the current collector 600. The outer gasket 400 and the inner gasket 500 are formed of, for example, a resin having electrical insulation properties such as polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), an ABS resin, or a composite material thereof.

The electrode assembly 700 is an energy storage element (power generating element) formed by winding plates and capable of storing electricity. The electrode assembly 700 has a long shape extending in the X-axis direction and has an oval shape as viewed in the X-axis direction. The electrode assembly 700 has a shape extended in the X-axis direction with a length in the X-axis direction of, for example, 300 mm or more, specifically, about 500 mm to 1500 mm. Thus, the electrode assembly 700 has a length in the X-axis direction greater than a length in the Z-axis direction. The electrode assembly 700 includes a body 710 and a plurality of tabs 720 protruding from the body 710, and the tab 720 is connected (joined) to the current collector 600 as described above. The plurality of tabs 720 protrudes as a pair from each of both end faces of the body 710 in the X-axis direction. For example, on an one end face of the body 710 in the X-axis positive direction, a positive electrode tab 721 is provided at the end in the Z-axis positive direction, and a negative electrode tab 722 is provided at the end in the Z-axis negative direction. On the other hand, on the other end face of the body 710 in the X-axis negative direction, the negative electrode tab 722 is provided at the end in the Z-axis positive direction, and the positive electrode tab 721 is provided at the end in the Z-axis negative direction. That is, the positive electrode tabs 721 and the negative electrode tabs 722 are arranged in an inverted (vertically inverted) manner as viewed in the X-axis direction between the one end face and the other end face of the body 710. Such a configuration of the electrode assembly 700 will be described in detail below.

### 2 Description of Configuration of Electrode Assembly 700

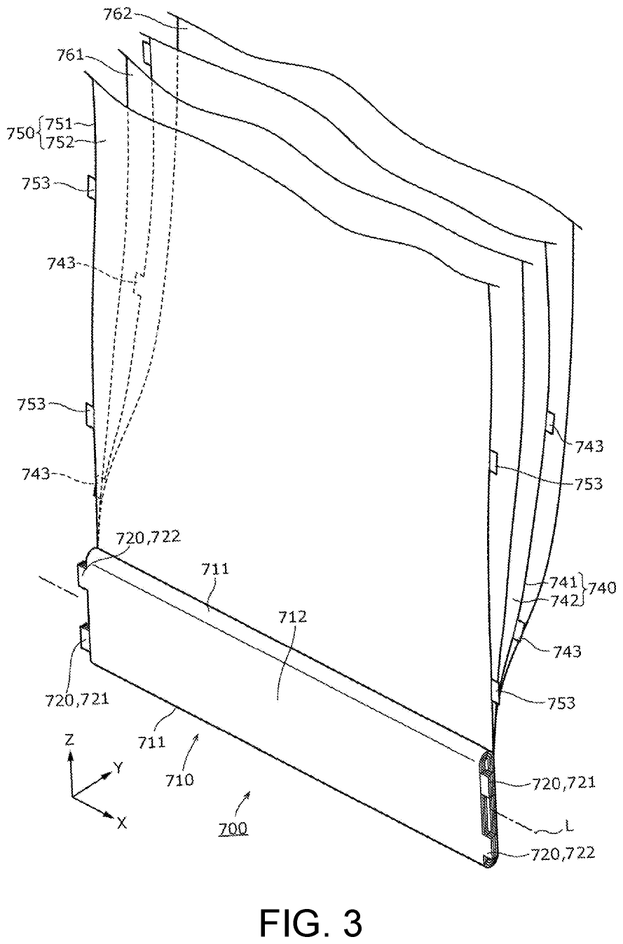

FIG. 3 is a perspective view illustrating the configuration of the electrode assembly 700 according to the present embodiment. Specifically, FIG. 3 illustrates the configuration of the electrode assembly 700 with the winding of plates in a partially unfolded state.

As illustrated in FIG. 3, the electrode assembly 700 includes a positive electrode plate 740, a negative electrode plate 750, and separators 761, 762.

The positive electrode plate 740 is an electrode plate in which a positive active material layer 742 is formed on a surface of the positive electrode substrate 741 that is a long strip-shaped metal foil made of aluminum, an aluminum alloy, or the like. The negative electrode plate 750 is an electrode plate in which a negative active material layer 752 is formed on a surface of the negative electrode substrate 751 that is a long strip-shaped metal foil made of copper, a copper alloy, or the like. As the positive electrode substrate 741 and the negative electrode substrate 751, any known materials such as nickel, iron, stainless steel, titanium, fired carbon, a conductive polymer, a conductive glass, or an Al-Cd alloy can be appropriately used as long as the materials are stable against oxidation-reduction reaction during charge-discharge. As the positive active material used for the positive active material layer 742 and the negative active material used for the negative active material layer 752, known materials can be appropriately used as long as the materials are a positive active material and a negative active material capable of occluding and releasing lithium ions.

For example, as the positive active material, it is possible to use a polyanion compound such as LiMPO₄, LiMSiO₄, or LiMBO₃ (M represents one or more transition metal elements selected from Fe, Ni, Mn, Co, and the like.), lithium titanate, a spinel type lithium manganese oxide such as LiMn₂O₄ or LiMn_{1.5}Ni_{0.5}O₄, a lithium transition metal oxide such as LiMO₂ (M represents one or more transition metal elements selected from Fe, Ni, Mn, Co, and the like.), or the like. Examples of the negative active material include lithium metal, a lithium alloy (lithium metal-containing alloys such as lithium-silicon, lithium-aluminum, lithium-lead, lithium-tin, lithium-aluminum-tin, lithium-gallium, and Wood's alloy), an alloy capable of occluding and releasing lithium, a carbon material (e.g., graphite, non-graphitizable carbon, graphitizable carbon, low-temperature calcined carbon, amorphous carbon, etc.), a silicon oxide, a metal oxide, a lithium metal oxide (Li₄Ti₅O₁₂, etc.), a polyphosphoric acid compound, and a compound of a transition metal and a group 14 to 16 element, such as Co₃O₄ and Fe₂P, which is generally referred to as a conversion negative electrode.

The separators 761, 762 are microporous sheets made of resin. As the material of the separators 761, 762, any known material can be appropriately used as long as the performance of the energy storage device 10 is not impaired. For example, as the separators 761, 762, it is possible to use a woven fabric insoluble in an organic solvent, a nonwoven fabric, a synthetic resin microporous membrane made of a polyolefin resin such as polyethylene, or the like.

The electrode assembly 700 is formed by alternately stacking and winding the positive electrode plate 740, the negative electrode plate 750, and the separators 761, 762. That is, the electrode assembly 700 is formed by stacking and winding the negative electrode plate 750, the separator 761, the positive electrode plate 740, and the separator 762 in this order. In the present embodiment, the electrode assembly 700 is a winding-type (so-called vertical winding-type) electrode assembly formed by winding the positive electrode plate 740, the negative electrode plate 750, and the like around a winding axis L extending in the X-axis direction. The winding axis L is a virtual axis that is a central shaft when the positive electrode plate 740, the negative electrode plate 750, and the like are wound, and in the present embodiment, the winding axis L is a straight line that passes through the center of the electrode assembly 700 and is parallel to the X-axis direction.

On both end edges of the positive electrode plate 740 in the winding-axis direction, a plurality of protruding pieces 743 protruding outward is arranged in a staggered manner in the plan view of the positive electrode plate 740. Similarly, at both end edges of the negative electrode plate 750 in the winding-axis direction, a plurality of protruding pieces 753 protruding outward are arranged in a staggered manner in the plan view of the negative electrode plate 750. In the state after stacking, each protruding piece 743 of the positive electrode plate 740 and each protruding piece 753 of the negative electrode plate 750 are alternately and repeatedly aligned in the longitudinal direction of the positive electrode plate 740 and the negative electrode plate 750, respectively. Each of the protruding pieces 743, 753 is a portion where the active material layer containing the active material is not formed and the substrate layer is exposed (active material layer non-formed portion).

When the positive electrode plate 740 and the negative electrode plate 750 and the separators 761, 762 are wound, the respective protruding pieces 743 of the positive electrode plate 740 are superimposed at the one end face and the other end face of the body 710, respectively and the respective protruding pieces 753 of the negative electrode plate 750 are superimposed at the one end face and the other end face of the body 710, respectively. A portion where the protruding pieces 743 of the positive electrode plate 740 are superimposed on each other is the positive electrode tab 721. That is, the positive electrode tab 721 is a part formed by stacking the plurality of pieces (protruding pieces 743) of one plate (positive electrode plate 740) having the same polarity out of the plurality of plates (positive electrode plate 740 and negative electrode plate 750).

Similarly, a portion where the protruding pieces 753 of the negative electrode plate 750 superimposed on each other is the negative electrode tab 722. That is, the negative electrode tab 722 is a part formed by stacking the plurality of pieces (protruding pieces 753) of one plate (negative electrode plate 750) having the same polarity out of the plurality of plates (positive electrode plate 740 and negative electrode plate 750).

That is, the electrode assembly 700 includes: the body 710 forming the body of the electrode assembly 700; and the plurality of tabs 720 (positive electrode tab 721 and negative electrode tab 722) protruding from a pair from each of both end faces of the body 710 in the X- axis direction.

The body 710 is a long columnar part (active material layer formed portion) formed by winding the portions of the positive electrode plate 740 and the negative electrode plate 750, in which the positive active material layer 742 and the negative active material layer 752 are formed (coated), and the separators 761, 762. Thereby, the body 710 includes a pair of curved portions 711 on both sides in the Z-axis direction and includes flat portions 712, which are flat as a whole, between the pair of curved portions 711. It can be said that the pair of curved portions 711 are located to sandwich the flat portion 712 in the Z-axis direction.

The curved portions 711 are curved parts curved in a semicircular arc shape to protrude in the Z-axis direction as viewed in the X-axis direction and extended in the X-axis direction, and are arranged to face the bottom wall of the case body 110 and the top wall of the lid 120. That is, the pair of curved portions 711 are parts curved to protrude on both sides in the Z-axis direction toward the bottom wall of the case body 110 and the top wall of the lid 120 as viewed in the X-axis direction. The flat portion 712 is a rectangular and flat part connecting the ends of the pair of curved portions 711 to each other and extending parallel to the XZ plane directed in the Y-axis direction, and is disposed to face the long sidewalls on both sides in the Y-axis direction of the case body 110. Note that the curved shape of the curved portion 711 is not limited to the semicircular arc shape, but may be a part of an elliptical shape or the like, and may be curved in any manner. The outer surface of the flat portion 712 facing the Y-axis direction is not limited to a flat surface, and the outer surface may be slightly recessed or slightly bulged. The respective tabs 720 are spaced apart from the curved portions 711 on both end faces of the body 710 and protrude from positions continuous with the flat portion 712.

### 3. Assembly of Electrode Assembly and Case

Next, the assembly of the electrode assembly and the case will be described. First, as illustrated in FIG. 2, in the lid 120, the pair of electrode terminals 300 (positive electrode terminal 310 and negative electrode terminal 320), the pair of current collectors 600 (positive current collector 610 and negative current collector 620), the pair of outer gaskets 400, and the pair of inner gaskets 500 are attached in advance to the respective short sidewalls that forms the pair of short side surfaces 101.

Thereafter, the electrode assembly 700 is disposed between the short sidewalls of the lid 120. At this time, the lid 120 is formed of the pair of short side surfaces 101 and the top surface 103 of the case 100, and each of spaces disposed in the pair of long side surfaces 102 sides is open between the pair of short side surfaces 101. It is sufficient to place the electrode assembly 700 between the short sidewalls from the open portion, so that the load on the electrode assembly 700 is also reduced.

After the placement, the respective electrode tabs 720 of the electrode assembly 700 and the respective current collectors 600 are joined to each other, whereby the lid 120 and the electrode assembly 700 are integrated to form an assembled unit. At this time, when the electrode assembly 700 is disposed between the pair of short side surfaces 101, the tab 720 and the current collector 600 can be joined to each other from one long side surface 102 side or the other long side surface 102 side. That is, the degree of freedom in joining the tab 720 and the current collector 600 is enhanced.

Next, in the case body 110, the assembled unit of the lid 120 and the electrode assembly 700 is assembled to the case body 110 such that the electrode assembly 700 is housed between the long sidewalls forming the pair of long side surfaces 102. After the assembling, the case body 110 and the lid 120 are joined by welding. For example, when the case body 110 and the lid 120 are joined by laser welding, the case body 110 and the lid 120 are preferably formed of aluminum or an aluminum alloy. For example, with aluminum having higher heat dissipation than steel use stainless (SUS), it is possible to reduce the amount of heat stored in the case body 110 and the lid 120 during welding. With such a configuration, it is possible to prevent the electrode assembly 700 from being affected by heat generated during welding.

When laser welding is performed, a laser beam may penetrate the case to damage the electrode assembly 700. In order to prevent this, it is sufficient to form a step on each of the joint surface of the case body 110 and the lid 120 and irradiate the boundary of the step with a laser beam.

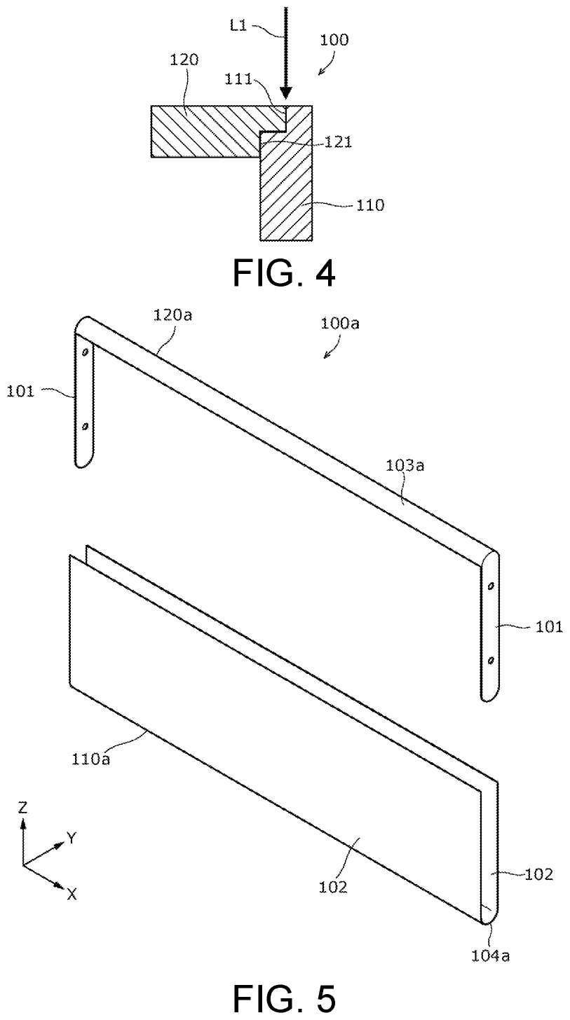

FIG. 4 is an enlarged cross-sectional view illustrating the joining structure of the case body 110 and the lid 120 according to the embodiment. A joint surface 111 of the case body 110 is formed in a stepped shape. Similarly, a joint surface 121 of the lid 120 is formed in a stepped shape. After the joint surface 111 of the case body 110 and the joint surface 121 of the lid 120 are superimposed so that their steps are assembled with each other, a laser beam L1 is emitted from the outside of the case 100 toward the boundary between the joint surfaces 111, 121. In this instance, the case body 110 is present ahead of the laser beam L1, so that the laser beam L1 is less likely to penetrate the inside of the case 100. Note that the joint surface 111 of the case body 110 and the joint surface 121 of the lid 120 may not be formed in a stepped shape.

### 4 Description of Effects

As described above, the energy storage device 10 according to the embodiment of the present invention includes the electrode assembly 700 formed by winding the plurality of plates (positive electrode plates 740 and negative electrode plates 750), and the rectangular parallelepiped case 100 housing the electrode assembly 700. The electrode assembly 700 includes the body 710 long in the winding-axis direction (X-axis direction) and the plurality of tabs 720 protruding as a pair from each of both end faces of the body 710 in the winding-axis direction. The case 100 is constructed by welding: the lid 120 formed of the pair of short side surfaces 101 of the case the pair of short side surfaces facing each other in the winding-axis direction, and the other one surface (top surface 103) of the case 100; and the case body 110 formed of three surfaces, except for the pair of short side surfaces 101 and the other one surface, of the case 100.

According to this, the lid 120 is formed of the pair of short side surfaces 101 and the other one surface of the case 100, so that the space between the pair of short side surfaces 101 is open in a state before assembly. Hence the electrode assembly 700 long in the winding-axis direction can be easily disposed between the pair of short side surfaces 101. Therefore, it is possible to reduce the load on the electrode assembly 700 during assembly.

The positive electrode tab 721 and the negative electrode tab 722 are provided as the pair of the tabs 720 on each of both end faces of the body 710. On each of the pair of short side surfaces 101 of the lid 120, the positive electrode terminal 310 and the positive current collector 610 are provided corresponding to the positive electrode tab 721, and the negative electrode terminal 320 and the negative current collector 620 are provided corresponding to the negative electrode tab 722.

According to this, the current collector 600 is joined to each tab 720 of the electrode assembly 700. However, as the electrode assembly 700 becomes larger and more current-carrying, the current collector 600 becomes thicker accordingly. The thick current collector 600 is difficult to deform. For example, even when an attempt is made to house the electrode assembly 700 in the case 100 after the current collector 600 is joined to the tab 720, there is a possibility that the current collector 600 cannot be smoothly housed in the case 100 because the current collector 600 is difficult to deform. In the present embodiment, the positive electrode terminal 310 and the positive current collector 610, and the negative electrode terminal 320 and the negative current collector 620 are provided on each of the pair of short side surfaces 101 of the lid 120, so that the respective tabs 720 can be joined to the respective current collectors 600 after the electrode assembly 700 is disposed between the pair of short side surfaces 101. Accordingly, the ease of assembly of the energy storage device 10 can be enhanced, and furthermore, the load on the electrode assembly 700 during assembly can also be reduced.

The lid 120 is formed of the top surface 103 of the case 100 as the other one surface, and the case body 110 is formed of the pair of long side surfaces 102 and the bottom surface 104 of the case 100 as three surfaces except for the other one surface. Therefore, each of spaces disposed in the pair of long side surfaces 102 sides is open between the pair of short side surfaces 101 in the lid 120. That is, when the electrode assembly 700 is disposed between the pair of short side surfaces 101, the tab 720 and the current collector 600 can be joined to each other from one long side surface 102 side or the other long side surface 102 side. This allows for a greater degree of freedom in joining the tab 720 and the current collector 600.

Of both end faces of the body 710, the positive electrode tab 721 and the negative electrode tab 722 provided on the one end face and the positive electrode tab 721 and the negative electrode tab 722 provided on the other end face are arranged in an inverted manner.

The inventor of the present application has found that when the positive electrode tabs 721 and the negative electrode tabs 722 are inverted between the one end face and the other end face of the body 710 of the electrode assembly 700, the resistance of the electrode assembly 700 during charge-discharge is reduced compared to when the positive electrode tab and the negative electrode tab are not inverted. That is, when the positive electrode tab 721 and the negative electrode tab 722 provided on the one end face of the body 710 of the electrode assembly 700 and the positive electrode tab 721 and the negative electrode tab 722 provided on the other end face of the body 710 of the electrode assembly 700 are arranged in an inverted manner in the body 710 of the electrode assembly 700, it is possible to reduce the resistance of the electrode assembly 700 during charge-discharge. This is suitable for the electrode assembly 700 that is long in the winding-axis direction and tends to have high resistance.

### 5 Description of Modification Examples

Each modification example of the above embodiment will be described below. In the following description, the same portions as those in the above embodiment are denoted by the same reference numerals, and the description thereof may be omitted.

### Modification Example 1

Next, Modification Example 1 of the above embodiment will be described. FIG. 5 is an exploded perspective view illustrating a case 100a according to Modification Example 1 of the embodiment. In the above embodiment, the instance in which the top surface 103 and the bottom surface 104 of the case 100 are planar has been exemplified. However, it is sufficient that the case has a substantially rectangular parallelepiped shape as a whole. For example, as illustrated in FIG. 5, a top surface 103a and a bottom surface 104a of the case 100a may be curved. Specifically, the bottom surface 104a of the case body 110a is curved to be convex in the Z-axis negative direction as viewed in the X-axis direction. The top surface 103a of the lid 120a is curved to be convex in the Z-axis positive direction as viewed in the X-axis direction. The lower end of each of the short sidewalls of the lid 120a is curved to correspond to the curvature of the bottom surface 104a of the case body 110a. In the energy storage device including such a case 100a, it is also possible to acquire substantially the same effects as the embodiment described above.

### Modification Example 2

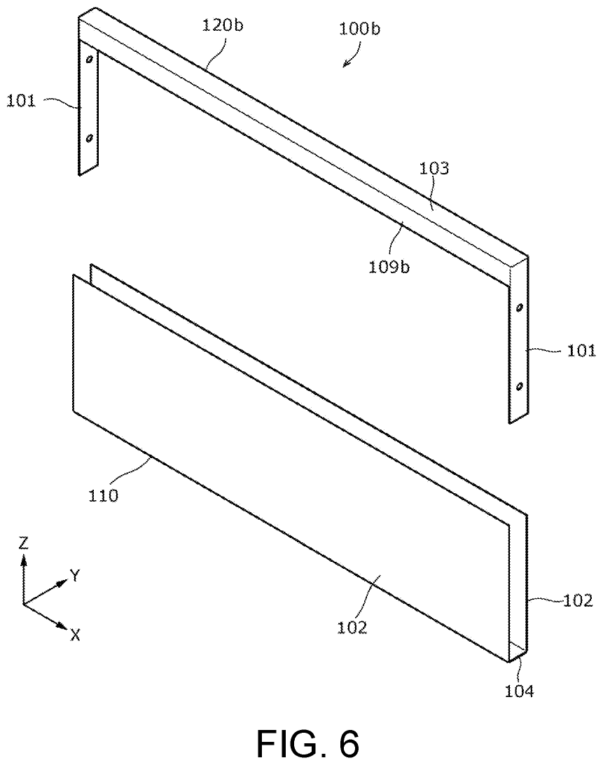

Next, Modification Example 2 of the above embodiment will be described. FIG. 6 is an exploded perspective view illustrating a case 100b according to Modification Example 2 of the embodiment. As illustrated in FIG. 5, a lid 120b of the case 100b is provided with a reinforcing portion 109b bridged between the pair of short side surfaces 101. Specifically, in the lid 120b, a pair of reinforcing portions 109b, which is continuous with both ends of the top surface 103 in the Y-axis direction, is formed (one reinforcing portion 109b is illustrated in FIG. 6). The one reinforcing portion 109b is a rectangular and flat part extended in the Z-axis negative direction from the end edge of the top surface 103 in the Y-axis negative direction. The other reinforcing portion 109b is a rectangular and flat part extended in the Z-axis negative direction from the end edge of the top surface 103 in the Y-axis positive direction. Each of the reinforcing portions 109b is extended in the X-axis direction and is bridged between the ends of the pair of short side surfaces 101 in the Z-axis positive direction. Each of the reinforcing portions 109b is welded to the end edge of the long sidewall of the case body 110 in the Z-axis positive direction. That is, each of the reinforcing portions 109b after welding forms a part of the long side surface 102 of the case 100b.

In this manner, the reinforcing portion 109b bridged between the pair of short side surfaces 101 is provided on the lid 120b, thereby making it possible to enhance the strength of the lid 120b. This stabilizes the shape of the lid 120b during assembly and can thus enhance the ease of assembly with the case body 110.

In the present modification example, the instance in which the pair of reinforcing portions 109b is provided has been exemplified, but only one reinforcing portion 109b may be provided. That is, the reinforcing portion may be continuous from only one end of the top surface in the Y-axis direction.

### Modification Example 3

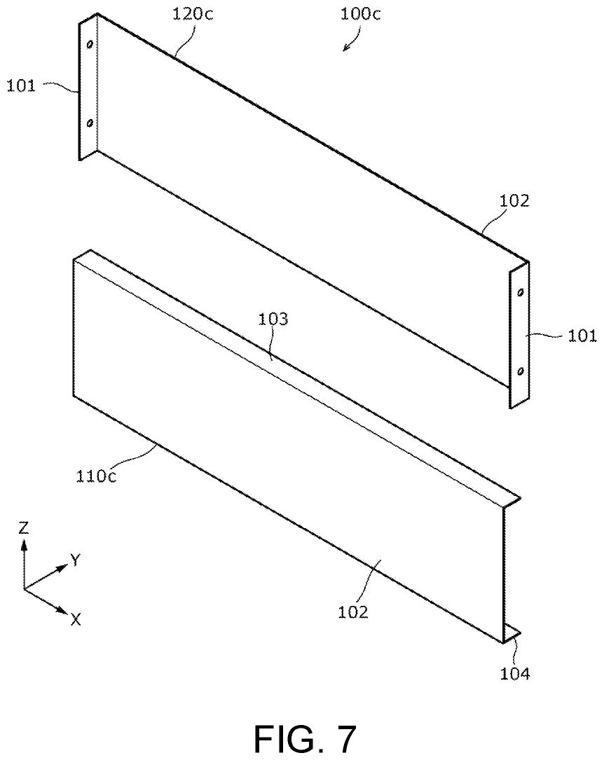

Next, Modification Example 3 of the above embodiment will be described. FIG. 7 is an exploded perspective view illustrating a case 100c according to Modification Example 3 of the embodiment. In the case 100 according to the above embodiment, the instance in which the lid 120 forms the pair of short side surfaces 101 and the top surface 103, and the case body 110 forms the pair of long side surfaces 102 and the bottom surface 104 has been exemplified. In the case 100c according to the present modification example, a lid 120c forms the pair of short side surfaces 101 and one long side surface 102, and the case body 110c forms the other long side surface 102, the top surface 103, and the bottom surface 104. Alternatively, the lid may form the pair of short side surfaces 101 and the bottom surface 104, and the case body may form the pair of long side surfaces 102 and the top surface 103.

In either instance, the space between the pair of short side surfaces 101 is open in a state before assembly, and hence the electrode assembly 700 long in the winding-axis direction can be easily disposed between the pair of short side surfaces 101. Therefore, it is possible to reduce the load on the electrode assembly 700 during assembly.

### Other Modification Examples

The energy storage device according to the embodiment of the present invention (including its modifications, which applies hereinafter) has been described above, but the present invention is not limited to the above embodiment. The embodiment disclosed herein is an example in all respects, and the scope of the present invention includes all modifications within the meaning and scope equivalent to the claims.

For example, in the embodiment described above, the instance has been described in which the positive electrode tabs 721 and the negative electrode tabs 722 of the one end face of the body 710 of the electrode assembly 700 are arranged in an inverted (vertically inverted) to the positive electrode tabs 721 and the negative electrode tabs 722 of the other end face of the body 710 of the electrode assembly 700, as viewed in the X-axis direction. However, the positive electrode tabs and the negative electrode tabs may not be inverted.

The scope of the present invention also includes forms constructed by arbitrarily combining the components included in the above embodiment and its modifications.

### INDUSTRIAL APPLICABILITY

The present invention can be applied to an energy storage device such as a lithium-ion secondary battery.

### DESCRIPTION OF REFERENCE SIGNS

10: energy storage device

100, 100a, 100b, 100c: case
101: short side surface
102: long side surface
103, 103a: top surface
104, 104a: bottom surface
109b: reinforcing portion
110, 110a, 110c: case body
111, 121: joint surface
120, 120a, 120b, 120c: lid
300: electrode terminal
310: positive electrode terminal
320: negative electrode terminal
330: shaft
400: outer gasket
500: inner gasket
600: current collector
610: positive current collector
620: negative current collector
630: first connection
640: second connection
700: electrode assembly
710: body
711: curved portion
712: flat portion
720: tab
721: positive electrode tab
722: negative electrode tab
740: positive electrode plate
741: positive electrode substrate
742: positive active material
743, 753: protruding piece
750: negative electrode plate
751: negative electrode substrate
752: negative active material layer
761, 762: separator

1. An energy storage device comprising:
an electrode assembly formed by winding a plurality of plates; and
a case of a rectangular parallelepiped shape housing the electrode assembly,
wherein the case is constructed by welding a lid and a case body,
the lid is formed of a pair of short side surfaces of the case, the pair of short side surfaces facing each other in a winding-axis direction of the electrode assembly, and formed of an other one surface of the case, and
the case body is formed of three surfaces, except for the pair of short side surfaces and the other one surface, of the case.

2. The energy storage device according to claim 1,
wherein an electrode terminal is provided on each of the pair of short side surfaces.

3. The energy storage device according to claim 1, wherein
the lid is formed of a top surface of the case as the other one surface, and the case body is formed of a pair of long side surfaces of the case and a bottom surface of the case as the three surfaces except for the other one surface.

4. The energy storage device according to claim 1,
wherein the electrode assembly includes:
a body long in the winding-axis direction; and
a tab protruding from each of both end faces of the body in the winding- axis direction.

5. The energy storage device according to claim 4, wherein a positive electrode tab and a negative electrode tab are each provided as the tab on each of both the end faces of the body, and
on each of the pair of short side surfaces of the lid, a positive electrode terminal and a positive current collector are provided corresponding to the positive electrode tab, and a negative electrode terminal and a negative current collector are provided corresponding to the negative electrode tab.

6. The energy storage device according to claim 5, wherein,
the positive electrode tab and the negative electrode tab provided on an one end face of both the end faces of the body, and the positive electrode tab and the negative electrode tab provided on an other end face of both the end faces of the body are arranged in an inverted manner.

7. The energy storage device according to claim 1,
wherein the lid includes a reinforcing portion bridged between the pair of short side surfaces.

8. The energy storage device according to claim 7,
wherein the reinforcing portion is provided continuously with each of a pair of ends of a top surface of the case, the pair of ends being along the winding-axis direction.

9. The energy storage device according to claim 1,
wherein stepped joint surfaces, superimposed to be assembled with each other, are formed on each of the case body and the lid.
